(19) United States
(12) Patent Application Publication
(10) Pub. No.: US 2026/0338928 A1
(43) Pub. Date: Oct. 29, 2026

(54) WIPER DEVICE

(71) Applicant: Robert Bosch GmbH, Stuttgart (DE)

(72) Inventors: Gyorgy Szabo, Budapest (HU); Janos Simonovics, Dunaharaszti (HU); Mate Hornyak, Pakozd (HU); Peter Deak, Budapest (HU); Zoltan Gyonyoru, Budapest (HU)

(21) Appl. No.: 19/099,140

(22) PCT Filed: Aug. 30, 2023
(86) PCT No.: PCT/EP2023/073781

§ 371 Date: Jan. 28, 2025

(30) Foreign Application Priority Data
Aug. 31, 2022 (DE) 10 2022 209 021.7

(51) Int. Cl. G01S 7/497; B60S 1/18; G01S 7/481; G01S 17/931

(52) U.S. Cl. CPC G01S 7/497; B60S 1/185; G01S 7/4813; G01S 17/931; G01S 2007/4977

(57) ABSTRACT

The invention relates to a wiper device comprising a wiper arm (28a; 28b), with at least one wiper blade (24a; 24b) which is coupled to the wiper arm (28a; 28b), and which has at least one wiper lip (26a; 26b) for wiping a surface (20a; 20b) of a protective element (18a; 18b) of a sensor device (14a; 14b), in particular a lidar device, which comprises a housing (16a; 16b) and a wiper arm guiding unit (30a; 30b), which is provided for moving the wiper arm (28a; 28b) at least substantially translationally along a guide path (32a; 32b), and which includes at least one bearing rail (36a; 36b) for that purpose.

It is proposed that, in at least one mode of operation, the wiper arm guiding unit (30a; 30b) is provided for moving the wiper arm (28a; 28b) into a parked position (62a; 62b) in a region next to the protective element (18a; 18b) to be wiped, in particular laterally next to the housing (16a; 16b).

### BACKGROUND

A wiper device with a wiper arm with at least one wiper blade, which is coupled to the wiper arm, and which has at least one wiper lip for wiping a surface of a protective element of a sensor device, in particular a lidar device, which comprises a housing and a wiper arm guiding unit, which is provided for moving the wiper arm at least substantially translationally along a guide path, and which includes at least one bearing rail for that purpose has already been proposed.

### SUMMARY

The invention is based on a wiper device with a wiper arm with at least one wiper blade, which is coupled to the wiper arm, and which has at least one wiper lip for wiping a surface of a protective element of a sensor device, in particular a lidar device, which comprises a housing and a wiper arm guiding unit, which is provided for moving the wiper arm at least substantially translationally along a guide path, and which includes at least one bearing rail for that purpose.

It is proposed that, in at least one mode of operation, the wiper arm guiding unit is provided for moving the wiper arm into a parked position in a region next to the protective element to be wiped, in particular laterally next to the housing.

The term “wiper device” is preferably intended to mean at least one part, preferably a subassembly, of a windshield wiper. The wiper device can preferably also comprise the entire windshield wiper, in particular comprising a wiper blade. Preferably, the wiper device is intended for use on a vehicle and on the sensor device. The wiper device, in particular as part of the windshield wiper, is preferably provided for cleaning a surface, preferably glass of the sensor device on a vehicle. The wiper device is preferably coupled to the vehicle. The term “provided” is preferably intended to mean specially designed, configured, arranged and/or equipped. An object being provided or designed for a specific function is preferably understood to mean that the object fulfills and/or performs this specific function in at least one application and/or operating state.

The sensor device is preferably designed as a lidar device. The sensor device is in particular at least one part, preferably at least one sub-module, of at least one lidar sensor, in particular of a lidar sensor module. The sensor device can in particular also comprise the entire lidar sensor, in particular the entire lidar sensor module. The sensor device preferably comprises at least one lidar unit which comprises in particular at least one lidar sensor element. In particular, the sensor device can comprise a plurality (e.g., two, three, four, five, or the like) of lidar sensor elements. The sensor device is preferably arranged on a vehicle for detecting the environment, in particular for autonomous driving. The sensor device can be arranged on construction sites for measuring buildings, for scanning 3-D contours and/or for research purposes in the laboratory. The sensor device, particularly by means of the at least one lidar sensor element, is in particular provided for detecting and/or measuring objects. Preferably, the wiper device is intended for use on a vehicle. The sensor device is preferably designed as a component of the vehicle. Alternatively, the sensor device can be designed as a retrofit kit for the vehicle. The sensor device is preferably provided for detecting objects in an environment of the vehicle. The sensor device, for detecting objects, is preferably coupled to the vehicle, preferably in a roof region, a front region, at least one lateral region, and/or one rear region of the vehicle. The sensor device is preferably connected to the vehicle, in particular to a computer unit, e.g., an onboard computer of the vehicle. The sensor device preferably comprises the protective element, in particular an aperture cover which in particular enables a laser beam to exit a housing of the sensor device, and which is in particular at least substantially transparent to detection wavelengths of the laser beam of the at least one lidar sensor element. The protective element is preferably designed as an aperture cover. The protective element, in particular the aperture cover, of the sensor device preferably defines the surface of the sensor device as an external face of the protective element, in particular of the aperture cover. The sensor device, in particular the protective element, preferably the aperture cover, is preferably at least partially arranged on an outer side of the vehicle. The protective element, preferably the aperture cover, preferably covers the sensor device at least partially, in particular in relation to the outside. For example, the protective element, preferably the aperture cover, is at least largely made of glass and/or a plastic.

The wiper blade, in particular by means of the wiper lip, is in particular provided for mechanically cleaning the protective element. The wiper lip is preferably designed to be rubber-like. The wiper arm guiding unit preferably comprises a drive unit which for cleaning the surface moves the wiper blade in a linear manner across the surface. The drive unit is preferably designed for moving the wiper blade along a path that is defined by the wiper arm guiding unit. The wiper arm guiding unit preferably defines a rectilinear path. The wiper device preferably comprises a connecting unit, by means of which the wiper arm and the wiper arm guiding unit are releasably connected to each other. The connecting unit is preferably designed as a snap-in connection. The wiper arm and a support element of the wiper arm guiding unit, in a completely assembled state, by means of at least one connection means are preferably connected to each other in a frictional and/or interlocking manner. The connection means, proceeding from two sides of the wiper arm that face away from each other, is preferably provided for mutually compressing the wiper arm and the support element. The drive unit is preferably designed for moving the wiper blade along the surface over the entire area, in particular for mechanically cleaning the entire area of the surface.

The wiper lip of the wiper blade is preferably designed to be replaceable. In particular, the wiper lip of the wiper blade can be designed to be replaceable without tools. The wiper lip is preferably arranged, in particular largely, in the wiper arm. A longitudinal axis of the at least one wiper arm is preferably oriented parallel to the at least one surface. A longitudinal axis of the at least one wiper arm is preferably oriented parallel to an external edge of the at least one surface. The at least one surface is preferably designed to be at least substantially rectangular. The at least one wiper arm preferably extends across at least one edge length of the at least one surface. The at least one wiper arm, on at least one end of an extent of the at least one wiper arm along the longitudinal axis of the at least one wiper arm, is preferably connected to the drive unit. A “longitudinal axis” of an object is to be understood in particular to signify an axis which runs parallel to a longest edge of a smallest geometric cuboid which only just completely encloses the object, and preferably runs through a geometric center of the object. The at least one wiper arm is preferably designed as an in particular metal strip which, in a cross-section perpendicular to the longitudinal axis of the at least one wiper arm, is a U-shaped strip. The at least one wiper arm preferably has a U-shaped profile, in particular in terms of the cross-section perpendicular to the longitudinal axis of the at least one wiper arm. The at least one wiper arm preferably delimits a wiper cavity, the wiper blade being largely arranged in the latter. Preferably, one open side of the wiper arm, particularly in relation to the U-shaped profile, faces the surface. Preferably, the drive unit is permanently connected to the vehicle or the sensor device.

A “wiper arm guiding unit” is intended to mean a unit that moves the wiper arm along a preferably straight guide path relative to the surface of the protective element to be wiped. “parked position” is preferably understood to mean a position of the wiper arm, into which it is placed when not in use. The wiper arm is in the parked position when the wiper device is at rest. The parked position of the wiper arm is, in particular, located laterally next to the housing of the sensor device. The parked position is, in particular, not located in an area which overlaps with an area of the protective element to be wiped. In the parked position, the wiper arm is moved out of an area in front of the protective element to be wiped. In the parked position, the wiper arm is preferably located behind cover elements in a protected manner.

“Laterally next to the housing” is preferably understood with respect to a view line perpendicular to the surface to be wiped, laterally next to the housing.

Due to the design of the wiper device according to the invention, the wiper arm can be arranged in a particularly advantageous position, in the parked position when not in use, i.e., when the protective element is not being cleaned. By positioning the parked position adjacent to the protective element to be wiped, in particular adjacent to the housing of the sensor device, the wiper arm can advantageously be parked in a poorly visible or non-visible area when not in use. A particularly advantageous appearance can thus be achieved. Furthermore, the wiper arm may be advantageously parked behind corresponding cover elements, wherein the wiper arm is particularly protected in the parked position. The wiper arm and the associated components of the wiper device, when in the parked position, can thus be protected particularly well from environmental influences and damage from the outside. With the design according to the invention, a particularly advantageous wiper device can be provided, which is particularly advantageously protected from damage.

It is further suggested that the wiper arm guiding unit comprises a guide rail provided for lifting the wiper arm with the wiper lip with a method into the parked position from the surface to be wiped. A “guide rail” is preferably to be understood as a rail, along which another element, such as the wiper arm in particular, is guided. The guide rail preferably has a contacting surface, into which the wiper arm or an element coupled to the wiper arm, such as a connecting element in particular, fits and is guided as a result.

The wiper arm can thus be particularly advantageously moved into the parked position.

Furthermore, it is proposed that the guide rail in a transition area to the parked position of the wiper arm has an elevation directed away from the surface to be wiped. The guide rail can thus be particularly advantageously configured to guide the wiper arm into the parked position.

It is further suggested that the wiper arm is intended to be connected to the bearing rail via two spring-loaded bearings. A “spring-loaded bearing” is preferably understood to mean a bearing, with the use of which two elements are mounted such that they are movable with at least one degree of freedom with respect to one another, wherein a spring element is provided that exerts a spring force on the elements that are mounted such that they are movable with respect to one another, and which acts in a direction, along which the elements are movable with respect to one another.

The wiper arm can thus be particularly advantageously mounted.

Furthermore, it is proposed that the wiper arm guiding unit comprises a connecting element via which the wiper arm is flexibly attached to the bearing rail. A “connecting element” is preferably understood to mean one element, through which two other elements are connected to one another. The wiper arm can thus be particularly advantageously connected to the bearing rail.

Furthermore, it is proposed that the wiper arm guiding unit comprises a first bearing configured as a rotational bearing, via which the wiper arm is connected to the connecting element, wherein the wiper arm guiding unit comprises a first spring element integrated into the first bearing that is intended to provide a preload force towards the surface to be wiped. The wiper arm can thus be mounted particularly easily to form a pretension.

In addition, it is proposed that the wiper arm guiding unit has a second bearing, via which the connecting element is coupled to the bearing rail, wherein the wiper arm guiding unit comprises a second spring element integrated into the second bearing. The connecting element is preferably not directly connected to the bearing rail. The connecting element is preferably connected to a guiding element that slides along the bearing rail. The connecting element is coupled to the bearing axis via the guiding element. This allows the connecting element to be particularly advantageously connected to the bearing rail to allow adjustment to the parked position.

It is further suggested that the second spring element of the wiper arm guiding unit has a greater stiffness than the first spring element. The spring elements can thus be particularly advantageously configured to enable simple and secure adjustment of the wiper arm to the parked position.

In addition, it is suggested that the second bearing is configured as a rotational bearing. The bearing can thus be configured particularly easily.

It is further suggested that the second bearing is configured as a linear bearing. As a result, the second bearing may be particularly easily configured for an adjustment movement of the wiper arm into the parked position.

Furthermore, it is proposed that the wiper device comprises a support element located adjacent to the surface to be wiped and is intended for the wiper lip or wiper arm to fit into it in the stowed position. A “support element” is preferably understood as an element that provides a support surface for the wiper blade or the wiper arm in the parked position, such that it does not pivot behind a plane of the surface to be wiped in the parked position. The wiper device can thus be configured to be particularly functionally reliable and the wiper arm can advantageously be secured in the parked position.

The wiper device according to the invention is not intended to be limited to the application and embodiment described above. In particular, the wiper device according to the invention can have a number of individual elements, components, and units that differ from a number mentioned herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. Two exemplary embodiments of the invention are shown in the drawings. The drawings, the description, and the claims contain numerous features in combination. A person skilled in the art will appropriately also consider the features individually and combine them into additional advantageous combinations.

Shown are:

FIG. 1 a schematic illustration of a vehicle comprising a sensor system in a first exemplary embodiment,

FIG. 2 a schematic illustration of the sensor system and of a wiper device according to the invention in the first exemplary embodiment,

FIG. 3 a schematic illustration of the sensor device with the wiper device in a side view, with a guide rail and two spring-loaded bearings, with a wiper arm during a wiping operation,

FIG. 4 a schematic top view of the sensor device with the wiper device, with the wiper arm during a wiping operation,

FIG. 5 a schematic side view of the wiper device with the wiper arm in its parked position,

FIG. 6 a schematic top view of the wiper device with the wiper arm in its parked position,

FIG. 7 a schematic illustration of a sensor device having a wiper device in a second exemplary embodiment with the wiper arm during a wiping operation, and

FIG. 8 a schematic side view of the wiper device with the wiper arm in its parked position.

### DETAILED DESCRIPTION

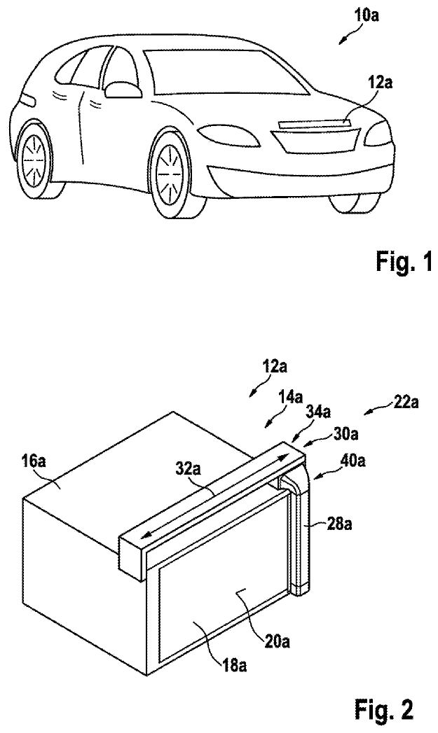

FIG. 1 shows a vehicle 10a. The vehicle 10a comprises a sensor system 12a. The sensor system 12a is designed as a lidar system. The vehicle 10a is designed as a road vehicle, in this case (by way of example) as a passenger motor vehicle. FIG. 2 shows the sensor system 12a in abstracted form and by way of example. The sensor system 12a comprises a sensor device 14a. The sensor device 14a is designed as a lidar device. The sensor device 14a is provided for detecting and/or measuring objects. The sensor device 14a is provided for use on the vehicle 10a. The sensor device 14a comprises at least one lidar sensor element (not shown). The sensor device 14a comprises a housing 16a. The housing 16a is configured as a sensor housing in which the lidar sensor element is arranged. The housing 16a preferably forms a cavity in which the lidar sensor element is located. The housing 16a has an opening. The sensor device 14a comprises a protective element 18a. In a mounted state, the opening of the housing 16a is closed by the protective element 18a. The sensor device 14a, in particular the protective element 18a, is arranged on an outer side of the vehicle 10a. The sensor device 18a is intended to enable a laser beam of the sensor device 14a to exit the housing 16a of the sensor device 14a and is, in particular, transparent to a detection wavelength of the lidar sensor element. The protective element 18a is designed as an aperture cover. The protective element 18a partially covers the sensor device 14a in relation to the outside. In particular, the protective element 18a forms a front part of the housing 16a of the sensor device 14a. The protective element 18a is made of glass and/or plastic, such as polycarbonate. The protective element 18a defines the surface 20a for the sensor device 14a as an external face of the protective element 18a. The surface 20a is designed to be rectangular. The protective element 18a forms part of an outer surface of the vehicle 10a and is, therefore, exposed to various environmental factors and can be soiled. For proper functioning of the sensor device 14a, it is important that the protective element 18a is as clean as possible, and therefore, the protective element 18a may need to be cleaned.

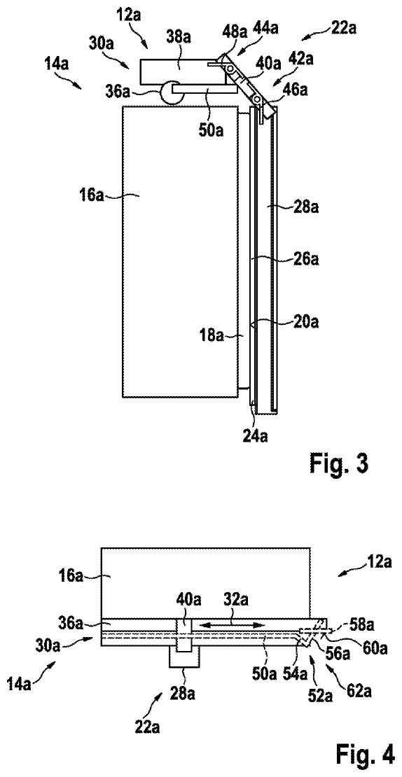

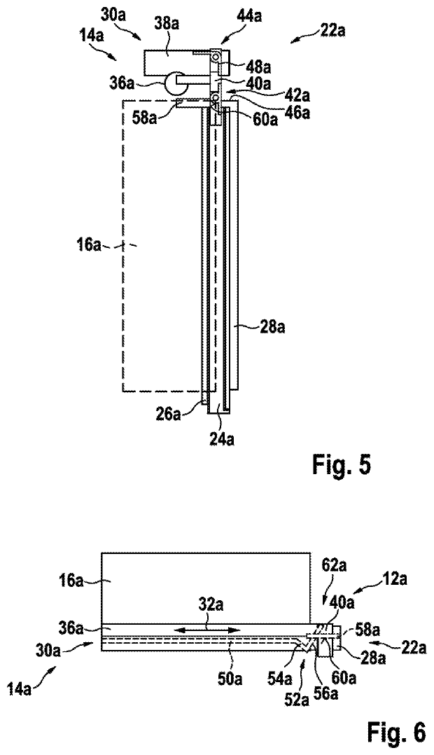

The sensor system 12a comprises a wiper device 22a. FIGS. 3 to 6 show the sensor system with the wiper device 22a in a first exemplary embodiment. The wiper device 22a is provided for wiping a surface 20a of the protective element 18a. The wiper device 22a is provided for mechanical cleaning of the protective element 18a, in particular the surface 20a of the protective element 18a. The wiper device 22a has a wiper blade 24a. The wiper blade 24a is provided for wiping a surface 22a of the protective element 16a. The wiper blade 24a has a longitudinal extension. The wiper blade 24a is rubber-like. The wiper blade 24a is, in particular, made of a natural and/or man-made elastomer. A longitudinal axis of the wiper blade 24a is aligned parallel to the surface 20a of the protective element 18a. The wiper blade 24a extends over a shorter edge length of the rectangular surface 20a of the protective element 18a. The wiper blade 24a, in a mounted state, extends over the entire expanse of the shorter edge length of the surface 20a of the protective element 18a. The wiper blade 24a has a wiper lip 26a. The wiper lip 26a of the wiper blade 24a, in a mounted state in at least one mode of wiping operation, contacts the surface 20a of the protective element 18a. The wiper lip 26a extends over the entire longitudinal length of the wiper blade 24a. The wiper lip 26a is located on a front side of the wiper blade 24a facing the protective element 18a, when mounted. In particular, the wiper blade 24a, in particular by means of the wiper lip 26a, is provided for mechanically cleaning the protective element 18a.

The wiper device 22a has a wiper arm 28a. The wiper arm 28a is provided to receive and store the wiper blade 24a. By means of the wiper arm 28a, the wiper blade 24a is moved relative to the protective element 18a of the sensor device 14a, in order to clean it. The wiper arm 28a is designed as a metal strip which, in a cross section perpendicular to a longitudinal axis, is U-shaped. The wiper arm 28a has a U-shaped profile, in particular in terms of the cross section perpendicular to the longitudinal axis. An open side of the wiper arm 28a faces the surface 20a of the protective element 18a when mounted. Preferably, a side of the wiper arm 28a that faces away from the surface 20a comprises, in particular, a flat external face in the mounted state. Preferably, the external face of the wiper arm 28a is oriented parallel to the surface 20a. The longitudinal axis of the wiper arm 28a is oriented parallel to an external edge of the surface 20a to be wiped. The wiper arm 28a extends the entire shorter edge length of the surface 20a of the protective element 18a. The wiper arm 28a delimits a wiper cavity in which the wiper blade 24a is largely located. The wiper arm 28a is rigidly formed. The wiper arm 28a is preferably formed from a plastic.

The wiper device 22a has a wiper arm guiding unit 30a. The wiper arm guiding unit 30a is provided for moving the wiper arm 28a at least substantially translationally along a guide path 32a. The wiper arm guiding unit 30a is provided to guide the wiper arm 28a, and thus the wiper blade 24a connected to the wiper arm 28a, over the surface 20a of the protective element 18a to be wiped. The wiper arm guiding unit 30a comprises a drive unit 34a which, for cleaning the surface 20 of the protective element 18a, moves the wiper blade 24a in a linear manner across the surface 20a. The drive unit 34a is designed for moving the wiper blade 24a along the guide patch 32a, which is defined by the wiper arm guiding unit 30a. The wiper arm guiding unit 30a defines a rectilinear path, in particular a rectilinear guide path 30a. The wiper arm 28a is connected to the drive unit 34a. For wiping, the wiper blade 24a is guided across the surface 20a by the drive unit 34a. The drive unit 34a is designed for moving the wiper blade 24a over the entire area along the surface 20a, in particular so as to mechanically clean the entire area of the surface 20a, whereby the entire area is particularly intended to mean that the wiper lip 26a bears along a longitudinal axis of the wiper lip 26a. The wiper arm guiding unit 30a, in particular the drive unit 34a, is rigidly connected to the sensor system 14a. For cleaning the surface 20a, the drive unit 34a is designed for moving the wiper blade 24a in a linear, and in particular bi-directional, manner across the surface 20a.

The wiper arm guiding unit 30a comprises a bearing rail 36a for translationally slidable bearing. The bearing rail 36a is configured as a linear bearing. The bearing rail 36a defines the guide path 32a, along which the wiper arm 28a is supported. The bearing rail 36a is preferably rigidly mounted to the housing 16a of the sensor device 14a. The bearing rail 36a is located on a top side of the housing 16a. The wiper arm guiding unit 30a comprises a guiding element 38a. The guiding element 38a is connected to the bearing rail 36a such that it is axially slidable. The guiding element 38a is positively coupled to the bearing rail 36a. Above the guiding element 38a, the wiper arm 28a is slidably supported along the guide path 32a on the bearing rail 36a. The wiper arm 28a is coupled to the guiding element 38a. The wiper arm 28a is preferably indirectly connected to the guiding element 38a.

The wiper arm guiding unit 30a comprises a connecting element 40a. The connecting element 40a is used to attach the wiper arm 28a to the bearing rail 36a. The connecting element 40a is provided to connect the wiper arm 28a to the guiding element 38a. The wiper arm 28a is connected to the guiding element 38a via the connecting element 40a. The connecting element 40a is provided to connect the wiper arm 28a to the bearing rail 36a. The connecting element 40a is used to flexibly connect the wiper arm 28a to the guiding element 38a. The connecting element 40a is located between the wiper arm 28a and the guiding element 38a. At a first bearing 42a, the wiper arm 28a is attached to the connecting element 40a. The first bearing 42a is located at a first end of the connecting element 40a. At a second bearing 44a, the connecting element 40a is connected to the guiding element 38a. The second bearing 44a is located at a second end of the connecting element 40a opposite the first end. Via the two bearings 42a, 44a, the wiper arm 28a is flexibly attached to the guiding element 38a. Via the two bearings 42a, 44a, the wiper arm 28a is flexibly attached to the bearing rail 36a.

The wiper arm 28a is provided to be connected to the bearing rail 36a via the two spring-loaded bearings 42a, 44a. The bearings 42a, 44a are configured to be spring loaded. The spring-loaded bearings 42a, 44a may advantageously press the wiper blade 24a, with its blade 26a, against the surface 20a of the protective element 18a to be wiped, during operation. This may achieve particularly advantageous cleaning results. A pressing force acting towards the surface 20a of the protective element 18a to be wiped is provided by the spring-loaded bearings 42a, 44a.

The wiper arm guiding unit 30a includes the first bearing 42a. The first bearing 42a is configured as a rotational bearing. Via the first bearing 42a, configured as a rotational bearing, the wiper arm 28a is pivotally coupled to the connecting element 40a. Via the first bearing 42a, configured as a rotational bearing, the wiper arm 28a is pivotally supported relative to the bearing rail 36a. The bearing 42a, configured as a rotational bearing, forms an axis of rotation. The wiper arm 28a is pivotally supported, about the axis of rotation of the bearing 42a, by the connecting element 40a. The axis of rotation of the bearing 42a is aligned parallel to the guide path 32a of the wiper arm guiding unit 30a. The wiper arm guiding unit 30a comprises a first spring element 46a. The first spring element 46a is integrated into the first bearing 42a. The first spring element 46a is intended to provide a preload force in the direction of the surface 20a to be wiped. During wiping, in a normal operating state the first spring element 46a is provided for pushing the wiper blade with its wiper tip 26a onto the surface 20a of the protective element 18a to be wiped. The first spring element 46a is operatively located between the connecting element 40a and the wiper arm 28a. The first spring element 46a is configured as a torsion spring. The spring element 46a configured as a torsion spring has a first leg coupled to the wiper arm 28a. The spring element 46a configured as a torsion spring has a second leg coupled to the connecting element 40a. As a result, the spring element 46a may impart a rotational torque on the wiper arm 28a from the connecting element 40a.

The wiper arm guiding unit 30a includes the second bearing 44a. The second bearing 44a is configured as a rotational bearing. The connecting element 40a is pivotally coupled to the guiding element 38a, i.e., the bearing rail 36a, via the second bearing 44a, configured as a rotational bearing. The second bearing 44a, configured as a rotational bearing, is pivotally supported by the wiper arm 28a relative to the bearing rail 36a. The second bearing 44a, configured as a rotational bearing, forms an axis of rotation. The connecting element 40a is pivotally supported, about the axis of rotation of the second bearing 44a, by the guiding element 38a. The axis of rotation of the second bearing 44a is aligned parallel to the guide path 32a of the wiper arm guiding unit 30a. The axis of rotation of the second bearing 44a is aligned parallel to the axis of rotation of the first bearing 42a. The wiper arm guiding unit 30a comprises a second spring element 48a. The second spring element 48a is integrated into the second bearing 44a. The second spring element 48a is intended to provide a preload force in the direction of the wiper arm 28a. During wiping, the second spring element 48a, in a normal operating state, is provided for pushing the wiper blade, with its wiper tip 26a, onto the surface 20a of the protective element 18a to be wiped. The second spring element 48a is operatively located between the guiding element 38a and the connecting element 40a. The second spring element 48a is configured as a torsion spring. The second spring element 48a, configured as a torsion spring, has a first leg coupled to the connecting element 40a. The second spring element 48a, configured as a torsion spring, has a second leg coupled to the guiding element 38a. As a result, the spring element 46a may impart a rotational torque on the connecting element 40a from the guiding element 38a.

By connecting the guiding element 38a to the wiper arm 30a via the bearings 42a, 44a, which are spring-loaded by means of spring elements 46a, 48a, the wiper blade 24a with its wiper lip 26a can be advantageously pressed against the surface 20a of the protective element 18a to be wiped during operation. The spring elements 46a, 48a provide the spring force for the pressing force required.

The wiper arm guiding unit 30a, in at least one operating state, is provided to move the wiper arm 28a to a parked position 62a in an area adjacent to the protective element 18a to be wiped, in particular laterally adjacent to the housing 16a. The parked position 62a is located adjacent to the housing 16a of the sensor device 14a. The parked position 62a is configured as a position of the wiper arm 28a and the associated wiper blade 24a in which the wiper blade 24a is not located in a region of the surface 20a of the protective element 18a to be wiped. The wiper blade 24a is located laterally adjacent to the protective element 18a in the parked position 62a. The wiper blade 24a is arranged with the wiper arm 28a adjacent to the housing 16a of the sensor device 14a. The wiper arm 28a is arranged in an orthogonal position to the surface 20a of the protective element 18a to be wiped laterally adjacent to the housing 16a of the sensor device 14a. In the parked position 62a, the wiper arm 28a is preferably located at least 3 mm, preferably more than 5 mm, and more preferably more than 8 mm, laterally adjacent to the housing 16a. By positioning the wiper arm 28a in the parked position 62a, the wiper arm 28a and associated wiper blade 24a may be advantageously located outside of a region in front of the protective element 18a of the sensor device 14a when not in use. As such, the wiper arm 28a is advantageously not seen from the outside or is difficult to see when not in use. Advantageously, damage to the wiper arm 28a and wiper blade 24a may also be advantageously reduced or prevented during non-use.

The wiper arm guiding unit 30a comprises a guide rail 50a. The guide rail 50a is provided to guide the wiper arm 28a along the guide path 32a in one method. During wiping, the guide rail 50a is intended to guide the wiper arm 28a such that the wiper lip 26a of the wiper blade 24a rests on the surface 20a of the protective element 18a to be wiped. The guide rail 50a is provided to lift the wiper arm 28a with the wiper lip 26a into the parked position 62a from the surface 20a of the protective element 18a to be wiped in one method. The guide rail 50a is located in an area of the bearing rail 36a. The guide rail 50a extends over a whole long width of the housing 16a of the sensor device 14a. The guide rail 50a extends into a portion of the parked position 62a of the wiper arm 28a. The guide rail 50a extends over the same area as the bearing rail 36a. The guide rail 50a forms a contacting area. The contacting area of the guide rail 50a faces the wiper arm 28a, and in particular the connecting element 40a. The contacting area is provided for the pivotably supported connecting element 40a to support itself on it. The rear side of the connecting element 40a fits into the contacting area of the guide rail 50a. The connecting element 40a fits into the contacting area of the guide rail 50a over the entire range of motion, in which the wiper arm 28a is slidably supported by the bearing rail 36a.

The guide rail 50a has an elevation 52a in a transition area to the parked position 62a of the wiper arm 28a. The elevation 52a of the guide rail 50a is directed away from the surface 20a of the protective element 18a to be wiped. As the elevation 52a is traversed, the connecting element 40a is pushed away from the protective element 18a. As a result, the connecting element 40a is pivoted away from the protective element 18a at its second bearing 44a, contrary to the spring force of the second spring element 48a.

By pivoting the connecting element 40a at its second bearing 44a relative to the guiding element 38a, the wiper arm 28a, and thus the wiper blade 24a with its wiper lip 26a, is lifted off the surface 20a of the protective element 18a to be wiped. As a result, the wiper blade 24a can be particularly gently lifted from the protective element 18a and transferred to the parked position 62a. The elevation 50a has a first partial area 54a that faces the area in front of the protective element 18a. Via the first partial area 54a, the wiper arm 28a is lifted away from the surface 20a of the protective element 18a after a wiping operation. The elevation 52a has a second partial area 56a that faces the parked position 62a. Via the second partial area 56a, the wiper arm 28a is brought into and out of the parked position 62a. The second partial area 56a, when viewed orthogonally to the surface 20a, extends further towards the surface 20a than the first partial area 54a.

The wiper device 22a has a support element 58a. The support element 58a is located adjacent to the surface 20a to be wiped. The support element 58a is located laterally adjacent to the housing 16a of the sensor device 14a. The support element 58a is located in an area of the parked position 62a of the wiper arm 28a. The support element 58a is provided for the wiper lip 26a of the wiper blade 24a to fit into it when in the parked position 62a. Generally, it would also be conceivable that the wiper arm 28a itself would fit into the support element 58a when in the parked position 62a. The support element 58a has a contact surface 60a, into which the wiper lip 26a of the wiper blade 24a fits when in the parked position 62a. The support element 58a, in particular the contact surface 62a of the support element 58a, is located in a direction that is orthogonal to the surface 20a of the protective element 18a when viewed in front of the surface 20a. The support element 58a is provided to prevent the wiper arm 28a from pivoting further in its parked position 62a towards the protective element 18a than it does during a wiping operation. The support element 58a is provided to prevent pivoting of the wiper arm 28a behind a plane of the surface 20a of the protective element 18a to be wiped.

When the wiper arm 28a is adjusted from its parked position 62a laterally adjacent to the housing 16a, the wiper arm 28a is pivoted away from the surface 20a of the protective element 18a to be wiped by the deflection of the connecting element 40a through the second partial area 56a of the elevation 52a of the guide rail 50a. The wiper arm 28a is moved towards the protective element 18a to be wiped. By guiding the connecting element 40a along the first partial area 54a of the elevation 52a of the guide rail 50a, the wiper arm 28a is pivoted towards the surface 20a of the protective element 18a to be wiped. The wiper blade 26a rests on the surface 20a to be wiped and is directed by the wiper arm guiding unit 30a along the guide path on the surface 20a. At the lateral end of the protective element 18a, the wiper arm guiding unit 30a reverses the movement of the wiper blade 28a, and it is shifted back toward its parked position 62a. If further cleaning cycles are carried out, the wiper arm guiding unit 30a reverses the direction of movement of the wiper arm 28a before the end of the protective element 18a, in particular before the elevation 52a of the guide rail 50a, and again moves the wiper blade 24a over the surface 20a to be wiped. If after cleaning, the wiper arm 28a is to be moved to its parked position 62a, the wiper arm guiding unit 30a moves the wiper arm 28a via the elevation 52a of the guide rail 50a, thereby deflecting the connecting element 40a contrary to the spring force of the second spring element 48a. Advantageously, the second spring element 48a of the wiper arm guiding unit 30a has a greater stiffness than the first spring element 46a. As a result, when the wiper arm 28a is moved, the wiper blade 28a may be lifted away from the surface 20a in a particularly easy manner by means of the elevation 52a of the guide rail 50a. The wiper arm guiding unit 30a passes over the elevation 52a with the wiper arm 28a. The wiper arm 28a is pivoted again towards the protective element 18a via the second partial area 56a of the elevation 52a and is parked on the support element 58a in the parked position 62a.

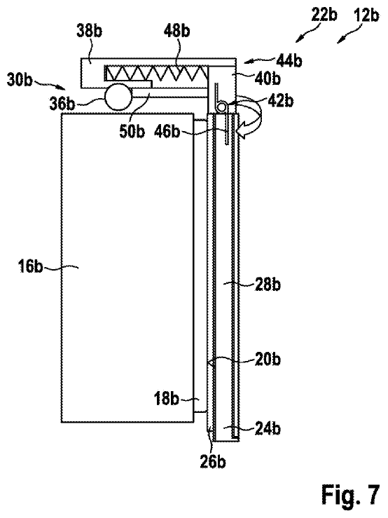

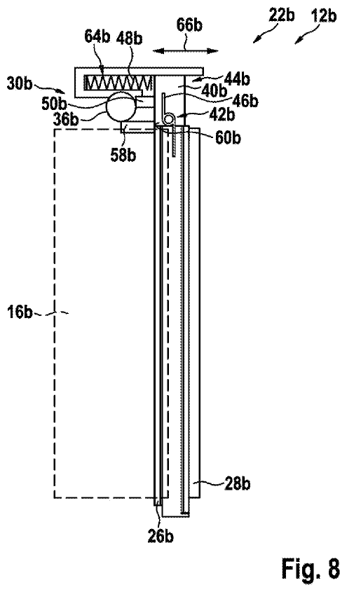

FIGS. 7 and 8 show a further exemplary embodiment of the invention. The following descriptions and the drawings are essentially limited to the differences between the exemplary embodiments wherein reference can, in principle, also be made, with respect to identically designated components, in particular with respect to components with the same reference numbers, to the drawings and/or the description of the other exemplary embodiments, in particular FIGS. 1 to 6. In order to distinguish between the exemplary embodiments, the letter a has been added to the reference numbers for the exemplary embodiment in FIGS. 1 through 6. In the exemplary embodiments of FIGS. 7 and 8, letter a is replaced by letter b.

FIGS. 7 and 8 show, by way of example, a sensor system 12b having a wiper device 22b in a second exemplary embodiment. The sensor system 12b comprises a sensor device 14b. The sensor device 14b comprises a housing 16b. The housing 16b is configured as a sensor housing in which the lidar sensor element is arranged. The sensor device 14b comprises a protective element 18b. The protective element 18b defines a surface 20b for the sensor device 14b as an outer surface of the protective element 18b.

The wiper device 22b is provided for wiping a surface 20b of the protective element 18b. The wiper device 22b has a wiper blade 24b. The wiper blade 24b is provided for wiping a surface 20b of the protective element 18b. The wiper blade 24b has a wiper lip 26b. The wiper device 22b has a wiper arm 28b. The wiper arm 28b is provided to receive and store the wiper blade 24b. The wiper device 22b has a wiper arm guiding unit 30b. The wiper arm guiding unit 30b is provided for moving the wiper arm 28b at least substantially translationally along a guide path 32b. The wiper arm guiding unit 30b comprises a bearing rail 36b for translationally slidable bearing. The bearing rail 36b is configured as a linear bearing. The wiper arm guiding unit 30b includes a guiding element 38b. The guiding element 38b is connected to the bearing rail 36b such that it is axially slidable. The guiding element 38b is positively coupled to the bearing rail 36b. Above the guiding element 38b, the wiper arm 28b is slidably supported along the guide path 32b on the bearing rail 36b.

The wiper arm guiding unit 30b comprises a connecting element 40b. The connecting element 40b is used to attach the wiper arm 28b to the bearing rail 36b. The connecting element 40b is provided to connect the wiper arm 28b to the guiding element 38b. The wiper arm 28b is intended to be connected to the bearing rail 36b via two spring-loaded bearing locations 42b, 44b. The bearings 42b, 44b are configured to be spring loaded. The spring-loaded bearings 42b, 44b may advantageously press the wiper blade 24b, with its blade 26b, against the surface 20b of the protective element 18b to be wiped, during operation. The wiper arm guiding unit 30b includes the first bearing 42b. The first bearing 42b is configured as a rotational bearing. The wiper arm guiding unit 30b comprises a first spring element 46b. The first spring element 46b is integrated into the first bearing 42b. The first spring element 46b is operatively located between the connecting element 40b and the wiper arm 28b. The first bearing is substantially the same as the corresponding bearing in the first exemplary embodiment.

The wiper arm guiding unit 30b includes the second bearing 44b. Unlike the first exemplary embodiment, the second bearing 44b is configured as a linear bearing. The connecting element 40b is supported by the guiding element 38b, such that it may be slid linearly, via the bearing 44b, configured as a linear bearing. The bearing 44b, configured as a linear bearing, has a linear guide rail that is connected to the guiding element 38b. The connecting element 40b forms a support element, via which the connecting element 40b is slidably supported by the linear guide rail of the guiding element 38b. The second bearing 44b, configured as a linear bearing, forms a sliding axis 66b, parallel to which the connecting element 40b is supported in a slidable manner by the guiding element 38b. The sliding axis is formed orthogonally to the guide path 32b of the bearing rail 36b. The sliding axis 66b preferably protrudes orthogonally with respect to the surface 20b of the protective element 18b to be wiped. The guiding element 38b includes a cavity 64b. The bearing 44b is located in the cavity 64b of the guiding element 38b. The connecting element 40b is slidably supported at least partially in the cavity 64b of the guiding element 38b.

The wiper arm guiding unit 30b comprises a second spring element 48b. The second spring element 48b is integrated into the second bearing 44b. The second spring element 48b is intended to provide a preload force in the direction of the wiper arm 28b. Unlike the first exemplary embodiment, the spring element 48b is configured as a tension spring element. The spring element 48b, configured as a tension spring, is located between the guiding element 38b and the connecting element 40b. The spring element 48b, configured as a tension spring, is located in the cavity 64b of the guiding element 38b. By connecting the guiding element 38b to the wiper arm 28b via the bearings 42b, 44b, which are spring-loaded by means of spring elements 46b, 48b, the wiper blade 24b with its wiper lip 26b can be advantageously pressed against the surface 20b of the protective element 18b to be wiped during operation.

The wiper arm guiding unit 30b, in at least one operating state, is provided to move the wiper arm 28b to a parked position 62b in an area adjacent to the protective element 18b to be wiped, in particular laterally adjacent to the housing 16b. The parked position 62b is located adjacent to the housing 16b of the sensor device 14b. The wiper arm guiding unit 30b comprises a guide rail 50b. The guide rail 50b is provided to guide the wiper arm 28b along the guide path 32b in one method. The guide rail 50b has an elevation 52b in a transition area to the parked position 62b of the wiper arm 28b. The elevation 52b of the guide rail 50b is directed away from the surface 20b of the protective element 18b to be wiped. The wiper device 22b has a support element 58b. The support element 58b is located adjacent to the surface 20b to be wiped. The support element 58b is located laterally adjacent to the housing 16b of the sensor device 14b. The wiper arm guiding unit 30b is substantially the same as in the first exemplary embodiment, wherein the function is also the same. Therefore, in order to avoid duplications, neither the wiper arm guiding unit 30b nor its function and the adjustment of the wiper arm 28b to the parked position 62b shall be described in more detail at this point. Reference is made here to the corresponding description of the first exemplary embodiment.

1. A wiper device having a wiper arm (28a; 28b), with at least one wiper blade (24a; 24b) coupled to the wiper arm (28a; 28b), the wiper blade (24a; 24b) comprises at least one wiper lip (26a; 26b) for wiping of a surface (20a; 20b) of a protective element (18a; 18b) of a sensor device (14a; 14b), the sensor device (14a; 14b) comprises a housing (16a; 16b), and which comprises a wiper arm guiding unit (30a; 30b), which is intended to move the wiper arm (28a; 28b) at least substantially translationally along a guide path (32a; 32b), and which includes at least one bearing rail (36a; 36b), wherein the wiper arm guiding unit (30a; 30b) is provided, in at least one mode of operation, for moving the wiper arm (28a; 28b) to a parked position (62a; 62b) into an area adjacent to the protective element (18a; 18b) to be wiped.

2. The wiper device according to claim 1, wherein the wiper arm guiding unit (30a; 30b) comprises a guide rail (50a; 50b) that is provided to lift the wiper arm (28a; 28b) with the wiper lip (26a; 26b) from the surface (20a; 20b) when moving to the parked position (62a; 62b) in one method.

3. The wiper device according to claim 2, wherein the guide rail (50a; 50b), in a transition area to the parked position (62a; 62b) of the wiper arm (28a; 28b), has an elevation (52a; 52b) directed away from the surface (20a; 20b) to be wiped.

4. The wiper device according to claim 1, wherein the wiper arm (28a; 28b) is connected to the at least one bearing rail (36a; 36b) via two spring-loaded bearings (42a, 44a; 42b, 44b).

5. The wiper device according to claim 1, wherein the wiper arm guiding unit (30a; 30b) comprises a connecting element (40a; 40b) via which the wiper arm (28a; 28b) is flexibly attached to the at least one bearing rail (36a; 36b).

6. The wiper device according to claim 5, wherein the wiper arm guiding unit (30a; 30b) comprises a first bearing (42a; 42b), configured as a rotational bearing, via which the wiper arm (28a; 28b) is connected to the connecting element (40a; 40b), wherein the wiper arm guiding unit (30a; 30b) comprises a first spring element (46a; 46b), which is integrated into the first bearing (42a; 42b) and is intended to provide a preload force towards the surface (20a; 20b) to be wiped.

7. The wiper device according to claim 6, wherein the wiper arm guiding unit (30a; 30b) comprises a second bearing (44a; 44b), via which the connecting element (40a; 40b) is coupled to the at least one bearing rail (36a; 36b), wherein the wiper arm guiding unit (30a; 30b) comprises a second spring element (48a; 48b) integrated into the second bearing 44b).

9. The wiper device according to claim 7, wherein the second bearing is configured as a rotational bearing.

10. The wiper device according to claim 7, wherein the second bearing is configured as a linear bearing.

11. The wiper device according to claim 1, wherein a support element (58a; 58b) is located adjacent to the surface (20a; 20b) to be wiped and is provided for the wiper lip (26a; 26b) or the wiper arm (28a; 28b) to fit therein in the parked position (62a; 62b).

12. A sensor system comprising at least one sensor device (14a; 14b), which comprises a protective element (18a; 18b), and with at least one wiper device (22a; 22b) according to claim 1, which is provided for wiping a surface (20a; 20b) of the protective element (18a; 18b).

13. A vehicle comprising at least one sensor system (12a; 12b) according to claim 12.

14. The wiper device according to claim 7, wherein the second spring element (48a; 48b) of the wiper arm guiding unit (30a; 30b) has a greater stiffness than the first spring element (46a; 46b).

15. The wiper device according to claim 1, wherein the sensor device (14a; 14b) is a lidar device.

16. The wiper device according to claim 1, wherein the parked position (62a; 62b) into the area adjacent to the protective element (18a; 18b) to be wiped is laterally next to the housing (16a; 16b).

17. The sensor system according to claim 12, wherein the sensor system is a lidar system and the at least one sensor device (14a; 14b) is a lidar device.
